(19) United States
(12) Patent Application Publication
(10) Pub. No.: US 2006/0058403 A1
(43) Pub. Date: Mar. 16, 2006

(54) METHOD AND SETUP FOR MANUFACTURING PRODUCTS FROM WASTE MATERIALS

(76) Inventors: Stanislaw ROGUT, Pyrzyce (PL); Miroslaw ZAKRZEWSKI, Pyrzyce (PL); Jerzy CWISZEWSKI, Zlotow (PL); Wieslaw WIESE, Zlotow (PL); Piotr JANKOWSKI, Zlotow (PL)

Correspondence Address: MATTHIAS SCHOLL, 14781 MEMORIAL DRIVE, SUITE 1319, HOUSTON, TX, 77079, US

(21) Appl. No.: 11/162,492

(22) Filed: Sep. 13, 2005

(30) Foreign Application Priority Data
Sep. 15, 2004 (PL) P-370120

(51) Int. Cl. C08J 11/04

(52) U.S. Cl. 521/40

(57) ABSTRACT

Taught herein are methods and apparatus for manufacturing products from waste materials. A method of manufacturing products from waste materials is characterized by the fact that waste material having water content above 20% is mixed rapidly with substance(s) of very high capacity for binding water and producing heat of hydration. An apparatus used for manufacturing products from waste material comprises a reaction chamber having a mixer 5 with cutting blades 8, scraper buckets 7 and driver 9. In the upper part of chamber 1, there is mixing pan 11 ending in a sieve 12. The walls of pan 11 contain chutes for feeding waste materials 14, chutes for feeding a reactant 15 and chutes for feeding a corrective agent 16. The bottom of chamber 1 is equipped with a system for product extraction 24 and a release gate valve 25.

### CROSS-REFERENCE TO RELATED APPLICATIONS

This application claims priority to the Polish Patent Application No. P-370120, filed Sep. 15, 2004, the contents of which are incorporated herein by reference.

### BACKGROUND OF THE INVENTION

1. Field of the Invention

The subject matter of the invention are methods and apparatus for manufacturing products from waste materials, and specifically methods and apparatus for manufacturing products from waste materials from slaughterhouse offal, animal processing, sludge, and plastics.

2. Brief Description of the Background of the Invention Including Prior Art

The known and used methods for processing and utilization of animal waste include fragmentation, sterilization, separation, and the subsequent use as fuels. Fragmentation and sterilization of animal waste are necessary to kill pathogenic organisms, bacteria, and viruses and to prevent biodegradation. Following fragmentation and sterilization, water is separated from the organic material, and fats are isolated by filtration or centrifugation. Large quantities of condensate created during the drying process are, however, generally difficult to purify because of the high concentration of organic ammonium compounds.

The dry residue remaining after fat separation is usually fragmented into animal meal, which is suitable for use as fuels in industrial furnaces. However, the relatively high fat content of conventionally processed animal waste (>10%) often results in commercial plants (e.g., cement plants) refusing to accept them as fuels because they tend to clog the fuel feeding systems, e.g., burners. The separated fats can also be used as fuel in systems where clogging does not present a problem.

The known methods for processing and utilizing organic waste in the form of sludge consist of sludge concentration, disinfection, filtration, and the subsequent use of the obtained product for either compost preparation or for burning at, e.g., a cement plant. Post-processed sludge products, however, are often more difficult to utilize than post-processed animal waste products because of their more random chemical composition and the presence of various, often very dangerous chemical compounds, used both in industry and in households, traveling along with sewage to sewage-treatment plants.

A common problem connected to the utilization of waste, and animal waste in particular, is the need for preliminary thermal treatment to bring about sterilization. Specifically, due to existing regulations in many countries, the majority of slaughterhouse offal and animal processing waste must be subjected to thermal sterilization, by keeping it at a specified high temperature for a specified period of time.

The process of sterilization is usually carried out in autoclaves heated with pressurized steam. One drawback of the process is that, independently of the processing scale, each system of thermal treatment requires the installation of costly heating equipment for the production of superheated high-pressure steam. Another drawback is that, in direct heating systems, where the steam permeates from the outside to the centre of the reaction chamber, it is necessary to continue the heating process for a prolonged time, so as to ensure that the batch subjected to thermal treatment has been adequately heated up throughout its entire mass. On the other hand, application of indirect heating with heating pipes located inside the reactor chamber requires the use of complex structural designs serving to empty and clean the reaction chamber from the residues of the thermal processing products.

Further, the design solutions utilizing superheated high-pressure steam being forced directly into the batch-containing reaction chamber not only increases the amount of condensate that is difficult to manage but also requires the reactor to be equipped with complicated safety devices, which makes it a subject to costly safety inspections.

In order to lower the capital costs, waste requiring sterilization is generally collected locally after cooling, and is transferred for utilization to industrial plants only after a proper amount is collected.

The purpose of the invention described herein is to eliminate the above-referenced inconveniences via the development of a methods and apparatus for processing of waste materials into products of full value and usability in the economy.

### BRIEF DESCRIPTION OF THE INVENTION

In one embodiment, the invention provides a method for manufacturing products from waste materials comprising: (a) mixing a waste material having a water content of over 20% by weight with a reactant having a high water binding capacity and a high heat of hydration; and (b) mechanically fragmenting and/or grinding the resulting mixture by extruding it through slits of predetermined shape; whereby resulting in (i) release of a substantial amount of heat leading to the vaporization of a significant fraction of water in the form of steam carried away from the mixture, (ii) binding of the remaining amount of water to the reactant to form a hydrate resulting in a product with heat-insulating properties, and (iii) continued release of the heat of hydration resulting in an increase of the temperature of said product.

In a class of this embodiment, the product is a porous product. In another class of this embodiment, the waste material and the reactant are mixed rapidly for 2 to 20 minutes. In another class of this embodiment, the reactant is a burnt lime. In another class of this embodiment, the reactant has a t₆₀ of between 0.5 and 4 minutes. In another class of this embodiment, the ratio of the reactant to the waste material is from 25% to 60% by weight.

In another class of this embodiment, the temperature is between 70° C. and 160° C. In another class of this embodiment, if said temperature increases above 160° C., the ratio of the reactant to the waste material is decreased, while if the temperature drops below 70° C., the ratio of the reactant to the waste material is increased. In another class of this embodiment, if the temperature increases above a level optimal for a given type of waste material, the flow of the reactant is reduced, while if the temperature drops below a level optimal for a given type of waste material, the amount of the reactant is increased.

In another class of this embodiment, the waste material is selected from the group consisting of slaughterhouse offal and animal processing waste.

In another class of this embodiment, the waste material is fragmented into particles with dimensions smaller than 12 mm.

In another class of this embodiment, the waste material is a sludge from sewage treatment plants.

In a subclass of this class, the invention provides a method for manufacturing products from waste materials comprising: (a) mixing a waste material having a water content of over 20% by weight with a reactant having a high water binding capacity and a high heat of hydration and with one or more corrective agents; and (b) mechanically fragmenting and/or grinding the resulting mixture by extruding it through slits of predetermined shape; whereby resulting in (i) release of a substantial amount of heat leading to the vaporization of a significant fraction of water in the form of steam carried away from the mixture, (ii) binding of the remaining amount of water to the reactant to form a hydrate resulting in a product with heat-insulating properties, and (iii) continued release of the heat of hydration resulting in an increase of the temperature of said product. In a subclass of this class, the corrective agents are admixed in the amount of 5 to 20% of the total corrective agents with respect to waste material by weight. In another subclass of this class, the corrective agents are selected from the group consisting of (1) screenings of burnt dolomite; (2) phosphorite; and (3) apatite.

In this subclass, the product is particularly a porous product. In this subclass, the waste material and the reactant are particularly mixed rapidly for 2 to 20 minutes. In this subclass, the reactant is particularly a burnt lime. In this subclass, the reactant has particularly a t₆₀ of between 0.5 and 4 minutes. In this subclass, the ratio of the reactant to the waste material is particularly from 25% to 60% by weight.

In another class of this embodiment, the waste material is thermoplastics waste.

In a subclass of this class, the invention provides a method for manufacturing products from waste materials comprising: (a) pre-mixing a waste material in granulated form with water in the amount of 5% to 40% by weight of water with respect to said waste material; (b) ad-mixing a reactant having a high water binding capacity and a high heat of hydration; (c) ad-mixing aluminum dust in the amount of 0.1% to 0.2% of aluminum dust with respect to waste material by weight; and (d) mechanically fragmenting and/or grinding the resulting mixture by extruding it through slits of predetermined shape; whereby resulting in (i) release of a substantial amount of heat leading to the vaporization of a significant fraction of water in the form of steam carried away from the mixture, (ii) binding of the remaining amount of water to the reactant to form a hydrate resulting in a product with heat-insulating properties, and (iii) continued release of the heat of hydration resulting in an increase of the temperature of said product.

In this subclass, the product is particularly a porous product. In this subclass, the waste material and the reactant are particularly mixed rapidly for 2 to 20 minutes. In this subclass, the reactant is particularly a burnt lime. In this subclass, the reactant has particularly a t₆₀ of between 0.5 and 4 minutes. In this subclass, the ratio of the reactant to the waste material is particularly from 25% to 60% by weight.

In another class of this embodiment, the waste material is a water emulsion of petroleum-derived waste.

In another class of this embodiment, the waste material is water emulsions of oily waste.

In one class of this embodiment, prior to mixing with the waste material, the reactant is earlier thoroughly mixed with one or more porous mineral substance(s) of high fluid-absorption capacity.

In another embodiment, the present invention provides an apparatus for manufacturing products from waste material comprising: a reaction chamber having a symmetry axis; a drive shaft; an electric engine; a gear; a mixer having a plurality of stirrer arms; a plurality of tilted scraper buckets; a plurality of vertical slats; a plurality of ventilating slits; a plurality of cutting blades; a driver having mixing and pushing elements; one or more mixing pans each having a rim and a cover and each ending with a sieve; one or more chutes for feeding waste material, reactant, and/or corrective agent; a means for product extraction; a gate valve; and one or more temperature sensors; wherein the drive shaft is located along the symmetry axis of the reaction chamber; the electric engine turns the drive shaft via the gear; the mixer is equipped with the stirrer arms mounted on the drive shaft; the tilted scraper buckets and the vertical slats are disposed on the stirrer arms; the ventilating slits are disposed in the upper part of the reaction chamber between the wall of the reactor and the rim of the mixing pan; the cutting blades are disposed underneath the mixer; the driver is disposed in the upper part of the drive shaft; the mixing pan(s) are in the form of a truncated cone with longitudinal sieve-like side and bottom slits, the mixing pan(s) being disposed in the upper part of the reaction chamber; the sieve being in the form of a truncated cone with longitudinal sieve-like side and bottom slits; the chutes for feeding waste material, reactant, and/or corrective agent are disposed in the upper part of the reaction chamber and are mounted in the walls of the mixing pan; the means for product extraction and the gate valve are located in the bottom portion of the reaction chamber; and the temperature sensor(s) are located in the reaction chamber and/or in a fume-extraction region.

In a class of this embodiment, the longitudinal sieve-like side and bottom slits are of the shape of an inverted trapezoid.

### BRIEF DESCRIPTION OF THE DRAWINGS

One of the many possible embodiments of the present invention is shown in the accompanying drawings, where:

FIG. 1 shows a waste product manufacturing system containing an apparatus according to the invention;

FIG. 2 shows the longitudinal section of the apparatus according to the invention;

FIG. 3 shows a top view of a sieve according to the invention;

FIG. 4 shows a side view of the sieve in the bottom part of the conical funnel;

FIG. 5 shows a cross-section of the sieve; and

FIG. 6 shows a cross-section of the upper part of the apparatus.

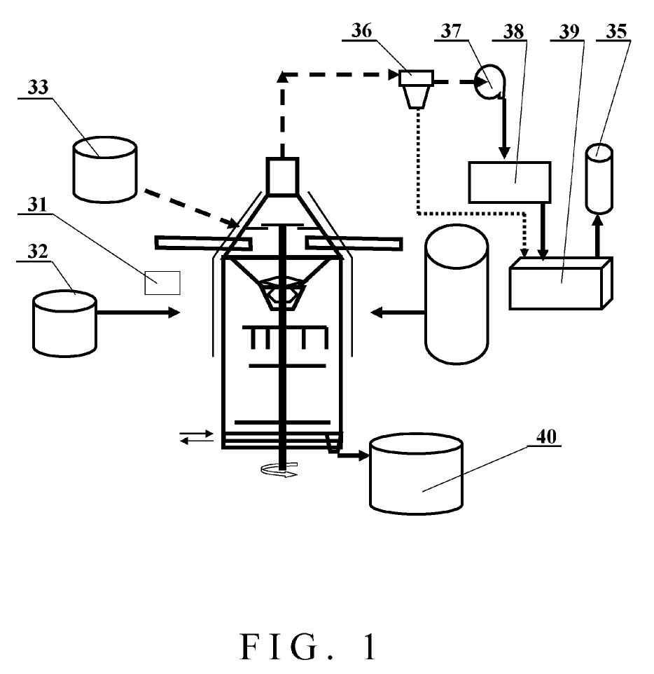

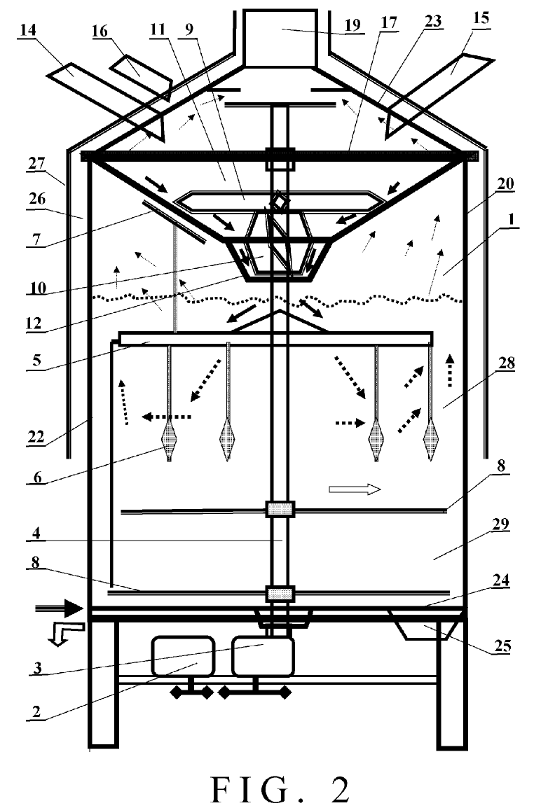

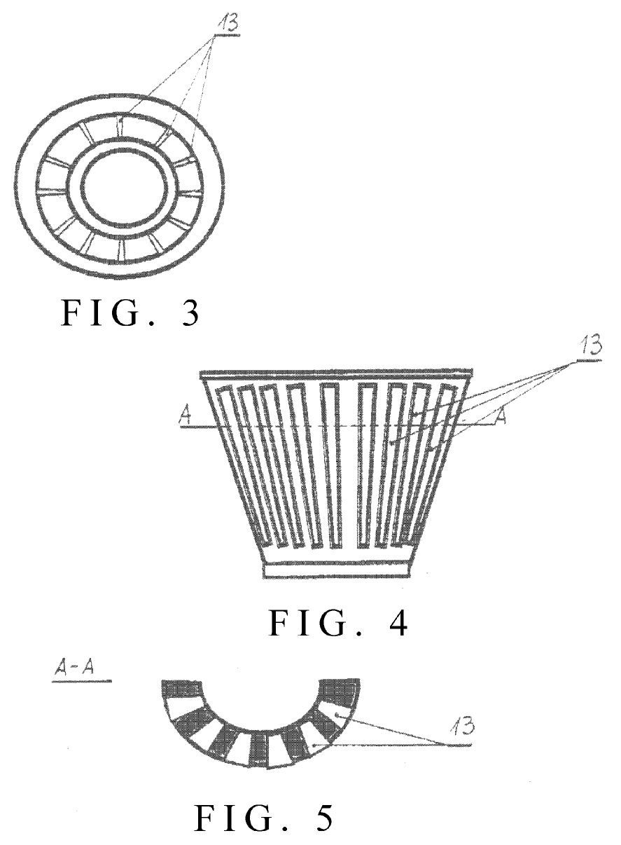

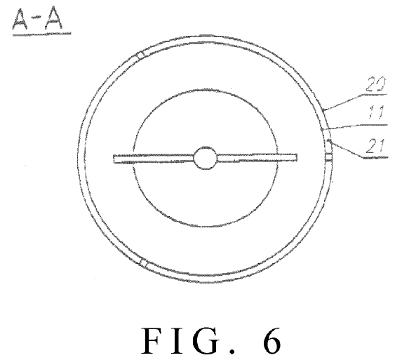

### DESCRIPTION OF INVENTION AND PREFERRED EMBODIMENT

In one embodiment of the invention, the method for converting waste materials into usable products is characterized by waste material with water content of above 20% being rapidly, i.e., for 2 to 20 minutes, mixed with a reactant of a very high capacity for binding water and for producing a high heat of hydration.

In one class of this embodiment, the reactant is ground burnt lime. In other class of this embodiment, the reactant is of high reactivity with 0.5 minutes<t₆₀<4 minutes. In another class, the reactant is mixed with the waste materials in a ratio of waste material to reactant ranging from 25% to 60% by weight.

In certain embodiments of the invention, the thoroughly mixed components are simultaneously pushed through slits of predetermined shape, thus undergoing mechanical fragmentation and grinding, while being subjected to exothermic hydration between the reactant and water contained in the waste, as a result of which, during a time interval much shorter than that of mixing, a large amount of heat is abruptly generated leading to the vaporization of a large fraction of water in the form of humid water vapour which is carried off to outside. The remaining part of water is bound by the reactant to form a hydrate creating a porous and dry product having heat-insulating properties, from which the heat of hydration continues to be released resulting in an increase of the product temperature, preferably to the level from 70 to 160° C.

In the case of temperature increase above the level optimal for processing a given type of waste material, the flow of the reactant is reduced, while in the case of a temperature drop below the optimum level, the amount of the reactant is increased.

The optimal temperature level for animal waste is 60 to 140° C. According to regulations in the European Union, animal waste is divided into three categories: for category I, the optimal temperature level is 140° C.; for category II, the optimal temperature level is 110° C., for category III, the optimal temperature level is 60° C. to 80° C. The optimal temperature level for sludge waste is 50 to 70° C.

In the case when the waste material consists of slaughterhouse offal and animal waste processing, it is fragmented into smaller particles. Particularly, such waste material is fragmented into particles of dimensions smaller than 12 mm.

In certain embodiments of the invention, as a result of the thermal and chemical decomposition of amino acids contained in the waste material, gaseous ammonia is generated, which assists the process of chemical and thermal sterilization of the waste materials processed.

The hot product thus obtained are then transferred into one or more curing chambers located outside the reaction chamber, where the process of chemical and thermal sterilization is continued at the temperature of up to 160° C. for a period ranging from 10 to 120 minutes. When the curing chamber is emptied, the product is cooled down to the ambient temperature and is gathered in a tank.

In certain embodiments of the invention, the waste material is sludge from sewage-treatment plants. In a class of this embodiment, a corrective agent is added to the mixture of waste material and the reactant. In another class of this embodiment, the corrective agent is screenings of burnt dolomite and/or phosphorite and/or apatites. In a class of this embodiment, the corrective agent is added in the amount ranging from 5 to 20% by weight of the corrective agent with respect to the waste material.

In a class of this embodiment, when products obtained from processing of waste materials are to be used as fertilizers, the corrective agent is a magnesium-based compound.

In certain embodiments, where the waste material consists of thermoplastics waste in granulated form, the waste material is mixed with water in the amount of from 5% to 40% by weight and with a frothing agent, particularly aluminum dust, in the amount of from 0.1% to 0.2% by weight, and the generated product in the form of a frothed substance of temperature from 130 to 160° C. is poured into a mould, at which time the processing ends and cooling to the ambient temperature occurs.

Frothing agents are generally added if waste materials consisting of plastics are to be converted into foam to be used as foam building insulation.

In the methods according to the invention, water emulsion of both petroleum-derived and oily waste is also used as a waste material.

In certain embodiments of the invention, it is essential that—before being mixed with the waste material—the reactant is thoroughly mixed with porous mineral substances of high fluid-absorption capacity.

In certain other embodiments of the invention, the temperature of the product transferred to the curing chambers is higher by 1 to 40° C. from the temperature set by the requirements defined by specific regulations concerning veterinary and microbiological safety.

The apparatus for manufacturing products from waste materials contains reaction chamber 1 in the form of a drum whose outside upper part is tucked in with a layer of insulating lining 26 covered with shield casing 27 made of metal sheet. In the lower part of the drum, electric engine 2 is seated, which turns via gear 3 the drive shaft 4 located along the symmetry axis of the chamber 1.

Mixer 5 with stirrer arms 6 is mounted on drive shaft 4. Tilted scraper buckets 7 are located on the arm of the mixer 5, with cutting blades 8 located below the mixer 5. In addition, on the arm of the mixer 5 vertical slats 22 are mounted, while in the upper part of drive shaft 4 driver 9 is mounted with mixing and pushing elements 10 located underneath. The upper part of the reaction chamber 1 contains a mixing pan 11 made in the form of a conical funnel and ending in its bottom part with sieve 12, also in the form of a truncated cone with slits 13 of the form of an inverted trapezoid, widening to the outside.

In the walls of mixing pan 11 are mounted the chutes feeding waste material 14, the chutes feeding the reactant 15, and the chutes feeding the corrective agent 16. The waste material-supplying chute 14 is connected to a buffer waste tank 33, while the chute supplying the reactant 15 is connected to a reactant reservoir 34 and the chute supplying the corrective agent 16 is connected to a corrective agent reservoir 32. On the outside of the reactor, under the waste-supplying chute 14, there is situated a feeder 31 for adjusting the amount of the supplied waste material, the reactant and the corrective agent.

Conical hood 18 of the fume extracting system ending in chimney 19 is situated above the cover 17 of the mixing pan 11. Ventilating slits 21 are located between the reactor wall 20 and the rim of pan 11. The bottom of reaction chamber 1 is equipped with a system for product extraction 24 and with a gate valve 25 for product release. Sets of temperature sensors 23, 28 and 29 are mounted in reaction chamber 1 in the region of fume extracting system 18.

In addition, in certain embodiments of the invention, the following devices are located on the outside of the reactor: filter 35, fan 37 of the fume extracting system, cyclone 36, condenser 38, absorber 39 and product tank 40.

The method and apparatus for manufacturing products from waste material according to the invention described herein makes it possible to obtain dry and non-sticky products, while delivering to the process an amount of heat energy several times smaller than in the classic methods of processing and drying, thanks to the phenomenon of abrupt heat generation from the components present in the process.

One of the advantageous results of the invention is the elimination of the biological hazard present in the currently-used methods of utilizing animal waste and sludge, as well as the elimination of the olfactory noxiousness, while retaining the fertilizing value of the nitrogen compounds contained in the sludge. In the case of products obtained from sludge and animal waste, the emission of nitrogen compounds into the atmosphere is substantially reduced.

In certain embodiments of the invention, the methods and apparatus may constitute an end unit of any process line involving, among others, animal and plastics waste, sludge, as well as water emulsions of petroleum-derived or oily waste. In certain embodiments of the invention, the methods and apparatus may be also used in harbors, at airports, on board of ships, or in restaurants, i.e. at all places where one can find waste constituting raw material for manufacturing the above-mentioned products according to the invention, and which so far have constituted environmentally harmful waste.

Definitions

For convenience, certain terms employed in the specification, examples, and appended claims are collected here.

It is to be understood that this invention is not limited to the particular methodology, protocols, constructs, and reagents described, as such may vary. It is also to be understood that the terminology used herein is for the purpose of describing particular embodiments only, and is not intended to limit the scope of the present invention which will be limited only by the appended claims.

The term “lime,” as used herein, includes “quicklime” and “hydrated lime”. Specifically, the term “lime” refers to any combination of calcium oxide (CaO), calcium hydroxide (Ca(OH)₂), or a mixture thereof, with magnesium oxide (MgO), magnesium hydroxide (Mg(OH)₂), or a mixture thereof. Lime may also include such impurities as calcium carbonate (CaCO₃), aluminum oxide (Al₂O₃), ferric oxide (Fe₂O₃), silicon dioxide (SiO₂), sulfur trioxide (SO₃), sodium oxide (Na₂O), phosphorus pentoxide (P₂O₅), potassium oxide (K₂O), titanium dioxide (TiO₂), manganese oxide (Mn₂O₃), strontium oxide (SrO), and other organic and inorganic impurities, in various amounts.

The terms “burnt lime,” “burned lime,” “quicklime,” and “oxide lime” as used herein, refer to any combination of calcium oxide (CaO) with magnesium oxide (MgO). Burnt lime may include such impurities as calcium carbonate (CaCO₃), calcium hydroxide (Ca(OH)₂), magnesium hydroxide (Mg(OH)₂), aluminum oxide (Al₂O₃), ferric oxide (Fe₂O₃), silicon dioxide (SiO₂), sulfur trioxide (SO₃), sodium oxide (Na₂O), phosphorus pentoxide (P₂O₅), potassium oxide (K₂O), titanium dioxide (TiO₂), manganese oxide (Mn₂O₃), strontium oxide (SrO), and other organic and inorganic impurities, in various amounts. Burnt lime used in embodiments of the invention, contains preferably a high ratio of calcium oxide with respect to the entire mixture, and particularly contains over 50% of calcium oxide, and more particularly over 60%, or 70%, or 80%, or 90%, or 95% of calcium oxide with respect to the entire mixture of compounds constituting burnt lime used.

Burnt lime is generally prepared by heating limestone to drive off carbon dioxide (CO₂). This changes the chemical form of the limestone from a carbonate to an oxide. Any hydrated lime in the limestone is also converted to calcium oxide by heating and driving off water. Burnt lime is sold in bags because of its powdery nature, unpleasant handling properties, and reactivity with moisture in air. It is a reactive and caustic material that produces heat when mixed with water. Thus, burnt lime must be handled carefully to avoid breathing the dust or contact with the skin and eyes.

The term “ground,” as used herein and as applicable to lime and burnt lime (“ground lime”, “ground burn lime”), refers to the particle size of lime or burnt lime. Specifically, “ground” as used herein means the particle size of burnt lime is smaller than 30 mm and particularly smaller than 20 mm, and more particularly smaller than 10 mm, or 5 mm, in diameter.

Particle size of ground lime or ground burnt lime, measured by standard size sieve mesh or directly in millimeters (mm), is one of the factors influencing the rate of reaction of lime with waste materials. The finer the grind, the more surface area is available to react with waste materials and the faster the reaction.

A 20-mesh sieve has 20 openings per linear inch or 400 openings per square inch, whereas 100-mesh sieve has 100 openings per linear inch or 10,000 openings per square inch. Burnt lime passing a 100-mesh sieve is smaller, has more surface area, and therefore reacts with waste material more rapidly than 20-mesh burnt lime.

The term “burnt dolomite,” as used herein, refers to any combination of calcium oxide (CaO) with magnesium oxide (MgO). Burnt lime may include such impurities as calcium carbonate (CaCO₃), calcium hydroxide (Ca(OH)₂), magnesium hydroxide (Mg(OH)₂), aluminum oxide (Al₂O₃), ferric oxide (Fe₂O₃), silicon dioxide (SiO₂), sulfur trioxide (SO₃), sodium oxide (Na₂O), phosphorus pentoxide (P₂O₅), potassium oxide (K₂O), titanium dioxide (TiO₂), manganese oxide (Mn₂O₃), strontium oxide (SrO), and other organic and inorganic impurities, in various amounts. The term “screenings of burnt dolomite,” as used herein, refers to burnt dolomite having particle sizes of 0-5 mm.

The term “phosphorite,” as used herein, refers to a sedimentary rock containing phosphate minerals. Most commonly it is a bedded primary or reworked secondary marine rock composed of microcrystalline carbonate fluorapatite in the form of laminae; pellets; oolites; nodules; skeletal, shell, and bone fragments; and guano.

The term “apatite” as used herein, refers to a group of minerals with the group formula Ca₅(PO₄)₃(F, Cl, OH). Individual apatite minerals are fluoroapatite (Ca₅(PO₄)₃F), chloroapatite (Ca₅(PO₄)₃Cl), and hydroxylapatite (Ca₅(PO₄)₃OH).

The term “hydration,” as used herein, refers to the reaction of burnt lime with water. Specifically, water reacts with calcium oxide in an exothermic reaction to form calcium hydroxide. (However, magnesium oxide will not readily react with water at normal temperatures and pressures.) During the slaking of lime, large amounts of heat are given off which can significantly rise the temperature of a slurry.

The parameter “t₆₀,” as used herein, refers to the amount of time needed for ground burnt lime to be heated from 20° C. to 60° C. when reacting with water. Therefore, t₆₀ is a measure of the reactivity of the reactant. Specifically, the lower the t₆₀ (i.e., the shorter the time for the temperature of the reactant to reach 60° C. when reacting with water), the higher the reactivity of the reactant (i.e., the greater its ability to generate the heat of hydration).

The term “heat of hydration” of a reactant, as used herein, refers to the quantity of heat (in Joules/gram of the reactant) liberated upon complete hydration of the reactant at a given temperature. For example, the heat of hydration of pure calcium oxide (CaO) is about 1186 J/g at normal temperatures and pressures. Of course, not all of the reactant used always hydrates and the degree of hydration of 100% may never be reached.

The term “high heat of hydration”, as used herein, refers to heat of hydration liberated upon complete hydration of the reactant at normal temperature which is at least 400 J/g, and particularly at least 600 J/g, and more particularly at least 800 J/g, or 1000 J/g.

Other compounds which exhibit high heats of hydration include, for example, tricalcium silicate (Ca₃SiO₅)—517 J/g, tricalcium aluminate (3CaO.Al₂O₃)—1144 J/g, and tetracalcium aluminoferrite (4CaO.Al₂O₃.Fe₂O₃)—725 J/g.

The term “water binding capacity” (“WBC”), as used herein, refers to the largest quantity of water that the reactant is able to hold firmly. Firmly held water is not removed by filtration and centrifugation. Firmly held water is held either by covalent bonds with the reactant (e.g., calcium oxide and water yielding calcium hydroxide) or by non-covalent bonds and other weak forces, such as, for example, hydrogen bonds and hydrophilic attractions (e.g., starch and water yielding swollen starch). Specifically, when calcium oxide is allowed to react with water, a tonne of calcium oxide would bind 320 litres of water. On the other hand, when potato starch is exposed to water at appropriate temperatures, it can bind as much as 1000 times its volume. Other superabsorbers which exhibit high water binding capacity include, for example, starch graft polymers (see U.S. Pat. No. 6,897,358) which can absorb 1000 g of water per one gram of polymer, and sodium polyacrylate, which can absorb as much as 400-800 times its mass in water.

The term “high water binding capacity,” as used herein refers to water binding capacity of at least 0.2 g of water per every g of reactant.

“Having water content of n %,” as used herein, refers to the weight ratio of water contained in the waste material. For example, if a waste material has a water content of 20% that means that for every 100 kg of waste material, the waste material contains 20 kg of water and 80 kg of other compounds.

The method according to the invention is explained more closely through the following non-limiting examples.

### EXAMPLE 1

Poultry offal with 82% water content was fragmented using known methods to particles with dimensions below 12 mm. Subsequently, a flow of constant volume in the amount of 2000 litres per hour was prepared and fed with a helical worm conveyor to mixing pan 11. Simultaneously, a flow of constant volume of ground burnt lime of high reactivity with parameter t₆₀ between 1 and 2 minutes (“HIGHREACTIVITY LIME” purchased from LHIOST) in the amount of 40% by weight relative to the waste processed was fed to reactor pan 11 through the reactant feeder 31. Additionally, a corrective agent in the form of screenings of burnt dolomite (“MILLED DOLOMITE” purchased from LHIOST), in the amount of 10% by weight relative to the waste processed was supplied through the corrective agent feeder.

The substrate flow was premixed in mixing pan 11 using the premixing arm, the so-called driver 9, leading to an initial contact between the substrates and to a displacement of the mixture components down towards the bottom, i.e., the center of pan 11. While progressing down in pan 11, the pre-mixed components were subjected to further mixing through the mixing elements mounted on stirrer 5, and, simultaneously, to mechanical fragmentation and grinding by being pushed through the sieve-like side slits and bottom slits 13 of the cone of pan 11. (At their perimeter, the side and bottom walls of pan 11, constructed in the form of a truncated cone, have longitudinal slits 13 widening to the outside, which prevents their clogging and choking by the moving reacting mixture.)

As a result of the exothermic reaction of hydration between the moisture contained in the waste and the reactant, hydration heat was generated in the reacting mixture, alongside the simultaneous phenomenon of intense evaporation of water vapor produced from moisture contained in the material under processing. While moving down in the reaction region of the reactor, the mixture is subjected to strong mixing and heating. The transient agglomerates and lumps of waste material fall apart spontaneously under the influence of the reaction process occurring in their interior, accompanied by the release of large quantities of water vapor.

While moving to the top of the reactor, the intense fumes released under the influence of the chemical reaction and composed mainly of humid water vapor and ammonia generated during the reaction of the reactant with proteins and amino acids present in the waste material, sweep around the lower part of the mixing pan, moving to its peripheral part equipped with one or more peripheral openings, in turn heating up pan 11 and the upper parts of the internal and external walls. The dominant part of moisture in the form of humid water vapor fumes was removed by the gas and fume extracting system, while the remaining part of water present in the material was simultaneously bound in a hydrate form.

The physical and chemical structure of the reacting mixture changing under the influence of the ongoing chemical process, and the accompanying transformation of the reacting mixture into a porous and dry product with heat-insulating properties lead to a decrease in thermal conductivity of the substance produced. The hygroscopic water contained inside the porous grains of the reactant kept continuously reacting with the burnt lime particles, releasing additional heat of hydration. At the same time, the mixture started to exhibit a deficiency of water able to absorb the hydration heat still released. With the increasing insulating capacity of the manufactured product, this lead to a rise in temperature.

As the process continued and the reacting mixture moved down into the region of product curing, the temperature of the reacting mixture increased from 140° C. to 160° C. However, it was advantageous to keep the temperature at the level of 150° C. The temperature sensor 28 located in the reaction region transfers the temperature data to the system controlling the amount of reactant fed into the reactor entrance. Whenever the temperature in the curing region rose to above 160° C., the reactant feeder system reduced the flow of the reactant by 10% in weight, while whenever the temperature in the curing region dropped below 140° C., the reactant feeder system increased the flow of the reactant by 10% by weight.

By changing the amount of the reactant and the intensity of mixing of the reacting mixture, and by cooling the reaction chamber, any temperature can be obtained in the reacting mixture from the ambient temperature to the temperature of equilibrium of the thermal distribution of the hydrate of the reactant. Specifically, when ground burnt lime of high reactivity is used as the reactant, it is possible to obtain temperatures ranging from the ambient temperature up to 500° C. in the reaction region of the reactor at the atmospheric pressure and without using any external heat sources.

The reaction products in form of a granulate at the temperature of 150° C. were fed by a worm conveyor to one of the three curing chambers, wherein they remained for a period of 25 minutes in order for the thermal and chemical sterilization to occur. Then, when the reaction process was completed, which was manifested by a decrease in the temperature of the product present in the chamber, the chamber was emptied to a tank with the help of an extracting system coupled to a cooling system, where the product collected in the product storing tank was cooled off to the ambient temperature.

The manufactured product was used as a calcium and magnesium organic fertilizer.

### EXAMPLE 2

The process is conducted in the way and using a apparatus as described in Example 1 with the difference that the processing is applied to dehydrated sludge from sewage treatment plants, containing 84% of water content.

The measured sludge flow of constant volume in the amount of 3000 liters per hour was fed with a conveyor device onto the mixing pan. Simultaneously, an appropriate amount of the reactant, in the form of ground burnt lime and/or chunked lime of high reactivity with parameter t₆₀ from 2 to 4 minutes in the amount of 35% by weight was supplied onto the pan via a feeder. As a result, as the reacting mixture moved down towards the region of product curing and later towards the reactor exit, the reacting mixture reached the temperature from 70° C. to 80° C. However, it is generally advantageous to maintain the temperature at the level of 75° C.

The data on the temperature in the reaction region is used for controlling the amount of the reactant fed at the reactor entrance. Specifically, when the temperature rises above 80° C. in the curing region, the reactant feeder reduces the flow of the supplied reactant by 15% by weight, and when the temperature drops below 60° C., it increases it by 15%. The reaction products in the form of a granulate having the temperature of 75° C. were carried by a worm conveyor to a storing tank, where the processing ended with the products subsequently cooled down to the ambient temperature. The manufactured products were used as soil enhancer, an organic calcium fertilizer, or an agent for sanitizing municipal landfill sites.

### EXAMPLE 3

The process is conducted as in Example 2 with the difference that the material to be processed constitutes thermoplastic waste originating from used packaging made of polyethylene and/or polypropylene and/or a mixture of polypropylene and polyethylene, fragmented down to particles with the size between 0-2 mm.

The granulated waste material was mixed with water in the amount of 12% by weight of water relative to the waste material, and with a frothing agent in the form of aluminum dust (“POWDERED ALUMINUM” purchased from LHIOST) in the amount of 0.2% by weight of the aluminum dust relative to the waste material. The prepared constant waste flow in the amount of 1000 kilograms per hour was subsequently supplied via a conveyor onto mixing pan 11. At the same time, an appropriate amount of the reactant, in the form of ground burnt lime of very high reactivity with the parameter t₆₀ between 0.5 and 2 minutes and in the amount of 15% by weight of the reactant relative to the waste material was supplied with a feeder onto mixing pan 11.

As a result of the process, as the reacting mixture moved down towards the region of product curing and later towards the reactor exit, the reacting mixture reached the temperatures ranging from 120° C. to 160° C. However, it is generally advantageous to maintain the temperature at the level of 140° C. The data on the temperature in the reaction region is used for controlling the amount of the reactant fed at the reactor entrance. The reaction products, advantageously in the form of a frothed substance of the temperature of 140° C., are poured into a mould, where the processing ends, followed by the products being cooled down to the ambient temperature. The manufactured product in the form of a porous substance possessing heat-insulating and bactericidal properties was used as a heat-insulating material, and, after fragmentation, as filler in columns for neutralization of acid sewage from industrial sewage treatment plants.

The particular embodiment having thus been described, it will now be evident to those skilled in the art that further modifications and variation thereto may be contemplated. Such modifications and variations are not regarded as a departure from the invention.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. A method for manufacturing products from waste materials comprising: (a) mixing a waste material having a water content of over 20% by weight with a reactant having a high water binding capacity and a high heat of hydration; and (b) mechanically fragmenting and/or grinding the resulting mixture by extruding it through slits of predetermined shape; whereby resulting in (i) release of a substantial amount of heat leading to the vaporization of a significant fraction of water in the form of steam carried away from the mixture, (ii) binding of the remaining amount of water to the reactant to form a hydrate resulting in a product with heat-insulating properties, and (iii) continued release of the heat of hydration resulting in an increase of the temperature of said product.

2. The method of claim 1, wherein said product is a porous product.

3. The method of claim 1, wherein said waste material and said reactant are mixed rapidly for 2 to 20 minutes.

4. The method of claim 1, wherein said reactant is a burnt lime.

5. The method of claim 1, wherein said reactant has a t₆₀ of between 0.5 and 4 minutes.

6. The method of claim 1, wherein the ratio of said reactant to said waste material is from 25% to 60% by weight.

7. The method of claim 1, wherein said temperature is between 70 and 160° C.

8. The method of claim 1, wherein if said temperature increases above 160° C., said ratio of said reactant to said waste material is decreased, while if said temperature drops below 70° C., said ratio of said reactant to said waste material is increased.

9. The method of claim 1, wherein if said temperature increases above a level optimal for a given type of waste material, the flow of the reactant is reduced, while if said temperature drops below a level optimal for a given type of waste material, the amount of the reactant is increased.

10. The method of claim 1, wherein said waste material is selected from the group consisting of slaughterhouse offal and animal processing waste.

11. The method of claim 10, wherein said waste material is fragmented into particles with dimensions smaller than 12 mm.

12. The method of claim 1 wherein said waste material is a sludge from sewage treatment plants.

13. The method of claim 12 wherein in (a) one or more corrective agents are further admixed with said waste material and said reactant.

14. The method of claim 13, wherein said corrective agents are admixed in the amount of 5 to 20% of the total corrective agents with respect to waste material by weight.

15. The method of claim 14, wherein said corrective agents are selected from the group consisting of (1) screenings of burnt dolomite; (2) phosphorite; and (3) apatite.

16. The method of claim 1 wherein said waste material is thermoplastics waste.

17. The method of claim 16, wherein said waste material is in granulated form premixed with water in the amount of 5% to 40% by weight; and in (a) aluminum dust is further admixed with said waste material and said reactant in the amount of 0.1% to 0.2% of aluminum dust with respect to waste material by weight.

18. The method of claim 1, wherein said waste material is a water emulsion of petroleum-derived waste.

19. The method of claim 1, wherein said waste material is water emulsions of oily waste.

20. The method of claim 1, wherein prior to mixing with said waste material, said reactant is earlier thoroughly mixed with one or more porous mineral substance(s) of high fluid-absorption capacity.

21. An apparatus for manufacturing products from waste material comprising:
a reaction chamber having a symmetry axis;
a drive shaft;
an electric engine;
a gear;
a mixer having a plurality of stirrer arms;
a plurality of tilted scraper buckets;
a plurality of vertical slats;
a plurality of ventilating slits;
a plurality of cutting blades;
a driver having mixing and pushing elements;
one or more mixing pans each having a rim and a cover and each ending with a sieve;
one or more chutes for feeding waste material, reactant, and/or corrective agent;
a means for product extraction;
a gate valve; and
one or more temperature sensors;
wherein
said drive shaft is located along the symmetry axis of said reaction chamber;
said electric engine turns said drive shaft via said gear;
said mixer is equipped with said stirrer arms mounted on said drive shaft;
said tilted scraper buckets and said vertical slats are disposed on said stirrer arms;
said ventilating slits are disposed in the upper part of said reaction chamber between the wall of said reactor and the rim of said mixing pan;
said cutting blades are disposed underneath said mixer;
said driver is disposed in the upper part of said drive shaft;
said mixing pan(s) are in the form of a truncated cone with longitudinal sieve-like side and bottom slits, said mixing pan(s) being disposed in the upper part of said reaction chamber;
said sieve being in the form of a truncated cone with longitudinal sieve-like side and bottom slits;
said chutes for feeding waste material, reactant, and/or corrective agent are disposed in the upper part of said reaction chamber and are mounted in the walls of said mixing pan;
said means for product extraction and said gate valve are located in the bottom portion of said reaction chamber; and
said temperature sensor(s) are located in said reaction chamber and/or in a fume-extraction region.

22. The apparatus of claim 21, wherein said longitudinal sieve-like side and bottom slits are of the shape of an inverted trapezoid.
